(19) United States
(12) Patent Application Publication
(10) Pub. No.: US 2014/0189362 A1
(43) Pub. Date: Jul. 3, 2014

(54) METHOD FOR A SECURED BACKUP AND RESTORE OF CONFIGURATION DATA OF AN END-USER DEVICE, AND DEVICE USING THE METHOD

(71) Applicants: Roeland Van Den Broeck, Schilde (BE); Dirk Van De Poel, Aartselaar (BE)

(72) Inventors: Roeland Van Den Broeck, Schilde (BE); Dirk Van De Poel, Aartselaar (BE)

(73) Assignee: THOMSON LICENSING, Issy de Moulineaux (FR)

(21) Appl. No.: 14/240,050

(22) PCT Filed: Aug. 30, 2012
(86) PCT No.: PCT/EP2012/066891

§ 371 Date: Feb. 21, 2014

(30) Foreign Application Priority Data
Aug. 31, 2011 (EP) 11447019.8

(51) Int. Cl. H04L 9/32; G06F 11/00; H04L 9/14

(52) U.S. Cl. CPC H04L 9/3247; H04L 9/3249; H04L 9/14; G06F 11/00
USPC 713/176

(57) ABSTRACT

The method for a backup and restore of configuration data of an end-user device comprises the steps: encrypting the configuration data by using symmetric-key encryption with a symmetrical key, signing the encrypted configuration data with a device private key, and sending the encrypted and signed configuration data to a personal computer of a user of the end-user device, and/or to a storage location of a service provider network, for storage. For restoring of configuration data intended for use within the end-user device, a first or a second public key of an asymmetric key encryption system is used for validating signed configuration data provided by the service provider network or for validating signed configuration data stored on the personal computer of the user.

### TECHNICAL FIELD

The invention relates to the field of end-user devices, in particular to remotely and/or centrally managed customer premises equipment devices operating via a broadband connection with a service provider network.

### BACKGROUND OF THE INVENTION

Residential gateways are widely used to connect devices in a home of a customer to the Internet or any other wide area network (WAN). Residential gateways use in particular digital subscriber line (DSL) technology that enables a high data rate transmission over copper lines. During the years, several DSL standards have been established differing in data rates and in range, for example ADSL and VDSL, which are referred to in this context as xDSL. But also optical fiber transmission systems for Internet services are well known using residential gateways, for example fiber-to-the-home (FTTH) and fiber-to-the premises (FTTP).

Network service providers (NSP), e.g. Internet service providers (ISP), have to manage a large amount, up to millions, of residential gateways, and also other devices such as routers, switches, telephones and set-top boxes, which are understood in this context as customer premises equipment (CPE) devices. Remote management of CPE devices can be achieved by means of a central configuration server (CCS), which interacts with individual CPE devices to provide them with configuration settings and to extract diagnostics information by using a specific application layer protocol.

A widely used example of a CPE remote management is known as the CPE WAN management protocol (CWMP), which was developed by the Broadband Forum and defined by a technical report 069, also commonly referred to as TR-069. The CWMP defines an application layer protocol for remote management of end-user devices, in particular of CPE devices, by providing a communication protocol between the CPE devices and an auto configuration server (ACS).

The CWMP is used in combination with device management data models. Data models are defined by the Broadband Forum in separate documents, for example in document TR-181i2, which defines a generic data model that can be applied to residential gateways and similar devices, and the document TR-135, by which set-top box specific data model parameters are defined.

A wide area network of this kind providing xDSL services for CPE devices is schematically shown in FIG. 1: a network service provider (NSP) network 1 is arranged for providing e.g. Internet services to a multitude of residential gateways 2 and set-top boxes 3 via a broadband connection 6, DSL/Cable/Fiber, . . . . In addition, the NSP network 1 includes an ACS 4 for remotely managing the residential gateways 2 and set-top boxes 3.

By using the TR-069 protocol 5, CWMP, the ACS 4 is in particular capable of auto configuration and dynamic service provisioning, software/firmware image management, status and performance monitoring and diagnostics for the residential gateways 2 and set-top boxes 3.

CWMP defines further how an ACS can instruct a CPE device to perform a configuration backup, e.g. by using an Upload Remote Procedure Call (RPC), as well as how to perform a configuration restore, by using a Download RPC. Also other protocols exist that support configuration backup and restore, e.g. the Open Mobile Alliance Device Management (OMA-DM). For such a mechanism, a number of important requirements and constraints have to be met:

First of all, configuration data needs to be confidential and not available in clear text by any or either:
The end-user of a CPE device
   The configuration data may contain service related secrets, e.g. passwords, that should not be exposed to the end-user.
The service provider
   The configuration data may contain private data that need to be protected and should only be accessible for the end-user, e.g. phonebook or calendar data.
The ACS operator, e.g. NSP
   Even while operating the remote management server, the service or subscriber related configuration data may not be accessible.
   The ACS operator might or might not be the Internet service provider.
The manufacturer of the CPE devices
   The manufacturer of the CPE devices should not have access to service related configuration data or subscriber private data.

Secondly, the configuration data cannot be altered by subscribers. This would allow a subscriber to gain capabilities that are not according to the service subscription. Configuration changes on the CPE device are typically done via a user-interface of the CPE device, providing a restricted capability for making configuration changes, or via a remote management server, e.g. done by an operator via the ACS on behalf of the service provider.

Thirdly, configuration data should only be restored on the device from which it was backed up. If configuration data contain subscription related settings, end-users should not be able to exchange configuration data files and to alter subscriptions outside of control of the service provider.

Fourthly, in case a CPE device needs to be replaced, e.g. because of malfunctioning or a service subscription change, it should be possible to restore configuration data from the old CPE device on the replacement device.

There is therefore a need for a mechanism to meet a number of important requirements and constraints for a CPE device, wherein the third and the fourth requirement appear to conflict and pose a challenge.

A symmetric-key encryption algorithm is an algorithm for encryption of data, which uses same cryptographic keys for both encryption of plain text and decryption of cipher text. Examples of symmetric-key encryption algorithms are for example AES, Serpent, Twofish, RC4 or 3DES.

Encryption of data does not guarantee that the data are not changed after encryption. Therefore, it is known to add a message authentication code (MAC) to encrypted data to insure that changes to the encrypted data will be noted by a receiver. A MAC is a short piece of information used to authenticate a message or encrypted data by signing it with the MAC. The MAC algorithm accepts as input a secret key and an arbitrary-length message to be authenticated, and allows a user, who also possess the secret key, to detect any changes to the message content.

Public-key cryptography is an asymmetric key cryptographic system requiring two separate keys, one of which is secret and one of which is public. The secret key and the public key are different but are mathematically linked. One of the keys can be used for encrypting or signing of data, and the other key can be used for decrypting the encrypted data, respectively validating the signed data. The secret key is also known as a private key. Public key cryptography can be used therefore for authentication of a message or encrypted data by using the private key for the digital signature. By using the public key, the integrity of the encrypted and signed data can be verified then in a later step by another user. A widely used asymmetric key algorithm is for example the RSA algorithm.

### SUMMARY OF THE INVENTION

The method for a backup and restore of configuration data of an end-user device comprises the steps of encrypting the configuration data by using symmetric-key encryption with a symmetrical key, signing the encrypted configuration data with a device-specific private key of an asymmetric key encryption system, sending the encrypted and signed configuration data to a personal computer of a user of the end-user device for a safe storage, or also or alternatively to a storage location of a service provider network for a safe storage.

For restoring of configuration data intended for use within the end-user device, a public key of the asymmetric key encryption system is used for validating signed configuration data provided by the service provider network or for validating signed configuration data stored on the personal computer. In particular, an administration public key is used as the public key for validating the signed configuration data as provided by the service provider network, and a device public key is used as the public key for validating signed configuration data stored on the personal computer of the user. The device-specific private key, the device public key and the administration public key of the asymmetric key encryption system are advantageously keys of an RSA public key algorithm. The restored configuration data are used in particular for replacing current configuration data of the end-user device.

In a further aspect of the invention, the shared secret key is common to a specific model of end-user devices of a service provider network, or is common to all of the end-user devices of the service provider network.

The end-user device comprises a memory including configuration data, a symmetric key for encrypting the configuration data for a backup operation, a private key of an asymmetric key encryption system for signing the encrypted configuration data, and at least a first public key of the asymmetric key encryption system for validating signed configuration data in case of restoring of configuration data. The end-user device comprises in particular a first, an administration public key of the asymmetric key encryption system for validating signed configuration data provided by a service provider network and a second, a device public key of the asymmetric key encryption system for validating signed configuration data stored by a user of the end-user device. The end-user device is for example a customer-premises equipment device, a tablet PC or a smartphone connected to a network service provider network.

### BRIEF DESCRIPTION OF THE DRAWINGS

Preferred embodiments of the invention are explained in more detail below by way of example with reference to schematic drawings, which show:

FIG. 1 a wide area network according to prior art, including CPE devices and a network service provider network for providing xDSL services, and

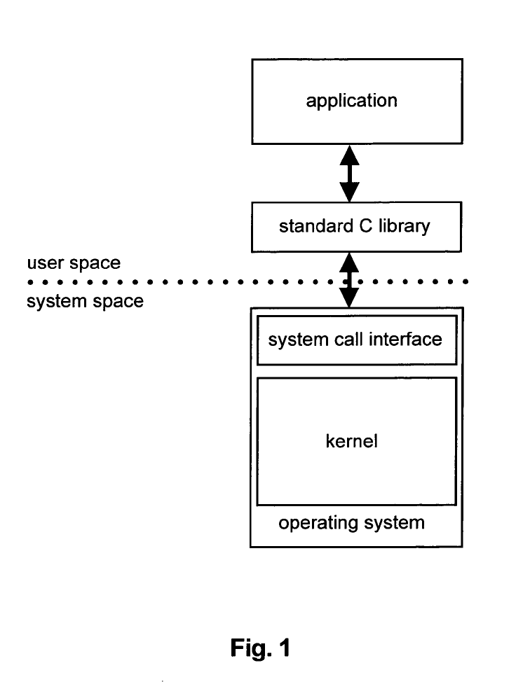

FIG. 2 an end-user device providing a secured backup and restore of configuration data according to the invention.

### DETAILED DESCRIPTION OF PREFERRED EMBODIMENTS

In the following description, example methods for a secured backup and restore of configuration data of an end-user device are described. For purposes of explanation, numerous specific details are set forth in order to provide a thorough understanding of preferred embodiments. It will be evident, however, to one skilled in the art that the present invention may be practiced without these specific details.

The method defines a security mechanism for an end-user device, in particular for a CPE device, by symmetrically encrypting configuration data of the end-user device by using a shared secret key, which makes sure that only entities knowing this secret key can read and decrypt the configuration data, whereby all or a part of the end-user devices of the network service provider (NSP) network are programmed with the same shared secret key. In addition, each end-user device adds its signature to the configuration data by using a private key of an asymmetric key cryptographic algorithm, in particular a device-specific private key, to sign the configuration data.

An end-user device only accepts new configuration data during a restore operation if at least one signature is present:
Its own signature is validated by its first public key as provided by the asymmetric key cryptographic algorithm, or
The new configuration data include an administration private key of a configuration administration unit of the NSP network or any other service provider. To validate the administration private key, the end-user device includes a second, an administration public key as provided by the asymmetric key cryptographic algorithm that is pre-programmed in the end-user device.

In case of a replacement of the end-user device, an administration private key is used to sign configuration data to be used for the new end-user device, the administration private key authorizing the new configuration data. The administration private key corresponds with the administration public key as provided by the asymmetric key cryptographic algorithm and pre-programmed in the end-user device, which administration public key is used for validating the new configuration data.

The end-user device according to the invention includes in a preferred embodiment a microprocessor, a non-volatile memory in which an operating system and configuration data are stored, and a volatile memory for the operation of the end-user device. The configuration data are a set of data being persistent on the end-user device and determine essentially the operation of the end-user device.

The end-user device is in a preferred embodiment a CPE device 10, for example a residential gateway, a router, a switch, a set-top box and so on. The operating system of the CPE device is for example a LINUX operating system and a CPE device-specific middleware, which is an execution environment including applications for providing for example a DSL modem function, gateway and switching functions, FXS functions, VoIP functionality and WI-FI operation.

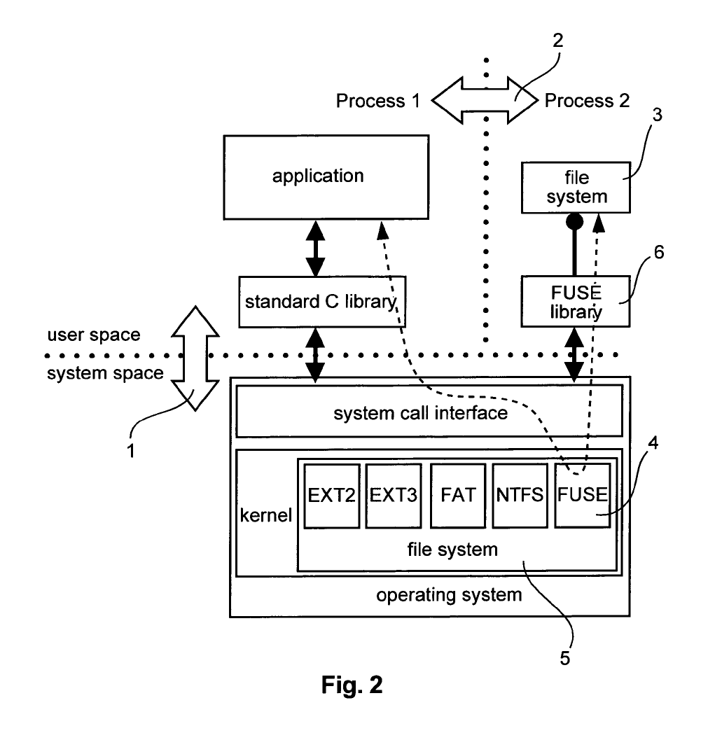

The CPE device 10 includes in a preferred embodiment a user interface 12, for example a WI-FI node, a LAN port or an USB port for a connection to a personal computer 20 of an end-user, e.g. a laptop, as shown schematically in FIG. 2. It includes further a CWMP client 13 coupled via a broadband connection 6 to a service provider network, e.g. an NSP network 30, and configuration data 11, for which secured backup and restore operations have to be provided. The backup and restore operations can be provided in particular by the end-user within its home network via the user interface 12 and the personal computer 20, or via the CWMP client 13 and a remote configuration storage of the NSP network 30, a storage location 32.

The CWMP client 13 is compliant with the broadband forum TR-069 standard for an operation with an auto-configuration server (ACS) 31 of the NSP network 30. Upon instruction of the ACS 31 for a backup operation, the CPE device 10 sends its configuration data 11 via the CWMP client 13 to the storage location 32 of the NSP network 30. For restoring of the configuration data as stored in the remote storage location 32, the NSP network 30 delivers the configuration data to the CWMP client 13 for storing the configuration data in the non-volatile memory of the CPE device 10, replacing the present configuration data.

The CPE device 10 comprises further a symmetrical, shared secret key 14, a device private key 15, a device-specific public key 16 and an administration public key 17. The shared secret key 14 is used to encrypt the configuration data 11, when a backup operation of the configuration data 11 is performed via the user interface 12 to the personal computer 20 or via the CWMP client 13 to the NSP network 30. For the shared secret key 14 for example an AES encryption standard is used. The device private key 15 is a private key of an asymmetric key cryptographic algorithm, for example an RSA private key, which is used to sign the encrypted configuration data as provided by the encryption of the configuration data 11 with the shared secret key 14.

The device public key 16 is a first public key of the asymmetric key cryptographic algorithm being used to validate the signed and encrypted configuration data in case of a restore operation with its device-specific configuration data, as stored on the personal computer 20 or the storage location 32. The administration public key 17 is a second public key of an asymmetric key cryptographic algorithm being used to validate encrypted configuration data being signed by the administration private key. The shared secret key 14, the device-specific private key 15 and the two public keys 16, 17 are stored for example in the non-volatile memory of the CPE device 10.

The NSP network 30 includes a configuration administration unit 33, which comprises an administration private key 34, for example an RSA private key. The administration private key 34 is private key of the asymmetric key cryptographic algorithm to be used by the configuration administration unit 33 to grant the right for the CPE device 10 to accept other configuration data, e.g. from another CPE device, not shown. The configuration administration unit 33 adds the administration private key 34 to the configuration data of the other CPE device to authorize that configuration data as new configuration data for the CPE device 10. In case the NSP wants to install the configuration data of the other CPE device on the CPE device 10, the NSP sends the configuration data of the other CPE device signed with its administration private key 34 via the ACS 31 to the CPE device 10. The CPE device 10 accepts the configuration data of the other CPE device only when its administration public key 17 matches the administration private key 34.

The method for a backup of the configuration data 11 of the CPE device 10 comprises in a preferred embodiment the following steps: An end-user may perform a backup at any time to restore a proper set of configuration data at a later point in time, e.g. because of a misconfiguration or a loss of the configuration data. For the backup operation, the end-user uses its personal computer 20 to interface with the interface of the CPE device 10 of the CPE device 10. The end-user uses for example an Internet browser of the CPE device 10 that is directed via a Hypertext Transfer Protocol (HTTP) command to an embedded web-server of the CPE device 10 serving as a graphical user interface. After opening the embedded web server, the end-user operates a backup function provided by the embedded web server, to activate and start the backup operation. The CPE device 10 then encrypts its configuration data 11 by using its shared secret key 14, signs the encrypted configuration data with its device private key 15 and sends the encrypted and signed configuration data via the user interface 12 to the personal computer 20, on which they are stored for example on a hard disk.

The end-user may later need to replace the current configuration data of the CPE device 10 with the older configuration data stored on the personal computer 20. The end-user then connects the personal computer 20 to the user interface 12 of the CPE device 10 and uses its Internet browser to open the embedded web server of the CPE device 10 to activate and start the restore operation for the CPE device 10. The previously backed-up encrypted and signed configuration data are then transferred from the personal computer 20 to the CPE device 10. The CPE device 10 will validate then the configuration data, and if a device signature is present and the device signature of the encrypted configuration data matches its own, in that the device private key 15 of the encrypted configuration data matches its device public key 16, then the configuration data are accepted and decrypted by the CPE device 10 by using its shared secret key 14. If there is no device private key included with the encrypted configuration data, or if there is an invalid device private key, then the configuration data are rejected.

In another embodiment, the NSP instructs an end-user device, e.g. the CPE device 10, via the ACS 31 to perform a backup operation of the configuration data 11 via its CWMP client 13. The ACS 31 uses the TR-069 CWMP to send an upload remote procedure call to the CPE device 10 instructing the CPE device 10 to upload its configuration data to a location indicated by a Uniform Resource Locator (URL). The CPE device 10 then uses for example a HTTP command to store the configuration data 11 in a location of the NSP network 30, e.g. in the remote storage location 32. The CPE device is responsible for uploading the configuration data 11 to the requested location: the CPE device 10 encrypts the configuration data 11 by using the shared secret key 14 and signs the encrypted configuration data with its device private key 15, and then uploads the encrypted and signed configuration data to the ACS 31 for storing in the storage location 32.

Upon a loss of its configuration data 11 or any other problem of the CPE device 10, which may be detected e.g. by the ACS 31 via the CWMP or the end-user may have called the help desk of the network service provider, the ACS 31 instructs the CWMP client 13 of the CPE device 10 to restore its configuration data as stored in the remote configuration storage 32. The ACS 31 uses the CWMP to send a download remote procedure call to the CWMP client 13 with an URL pointing to the configuration data stored in the remote configuration storage 32. The CPE device 10 then downloads the configuration data via the CWMP client 13 and checks the validity of the configuration data: The configuration data are only accepted when the signature of the configuration data matches the device public key 16, which is an indication that the restored configuration data are an older version of the configuration data of the CPE device 1, or if an administration private key 34 of the NSP network 30 is included which is an indication for the CPE device 1, that a new set of configuration data should replace the present configuration data of the CPE device 1. The administration private key 34 may optionally contain the device identity.

In another embodiment, the network service provider of the NSP network 30 wants to replace the CPE device 10 of an end-user being by a new CPE device because the CPE device 10 is outdated. In this case, it is advantageous to migrate the configuration data 11 of the old device 10 to the new CPE device, which in practice restores the exact functionality, e.g. the wireless network settings of the home network of the end-user, so that all of the wireless devices of his home network can connect to the new CPE device without needing to reconfigure the wireless devices. The old CPE device 10 and the new CPE device are in particular residential gateways.

Before replacing the old CPE device 10, the end-user performs a backup of its configuration data 11 to the remote storage location 32 of the network service provider, or the network service provider requests a backup of the configuration data 11 via the auto-configuration server 31 by using CWMP. Before uploading, the CPE device 10 encrypts the configuration data 11 by using the shared secret key 14 and signs the encrypted configuration data with its device private key 15, as described before. Then, the old CPE device 10 is replaced by the new CPE device in the home of the end-user.

In a further step, the configuration administration unit 33 within the NSP network 30 signs the configuration data as uploaded and stored in the remote configuration storage 32 with its administration private key 34, which authorizes the configuration data for acceptance by the new CPE device. Optionally, a device specific identity of the new CPE device may be included with the administration private key 34, so that only one specific CPE device, the new CPE device of the end-user, will accept the configuration data. The signed configuration data will then be transmitted by the NSP network 30 to the new CPE device by using the ACS 31, and in a further step, the new CPE device validates the administration private key 34 as included with the configuration data by using its administration public key 17. The transferred configuration data will then be decrypted and stored as the configuration data of the new CPE device and used for the operation of the new CPE device.

The invention thus uses a first pair of asymmetric keys, the device private key 15 and the device public key 16, and a second pair of asymmetric keys, the administration private key 34 and the administration public key 17, for the security of the configuration data, in addition with the symmetric shared secret key 14. Configuration data are only accepted by the end-user device if the signature of the configuration data matches its device public key 16, or in case the signature of the configuration data does not match its device public key 16, if an administration private key of a service provider is included with the configuration data, which matches its administration public key 17.

In another embodiment, the end-user may replace its old tablet-PC, or smartphone, by a newer model of the same manufacturer. The end-user performs then a backup of the configuration data of the old tablet-PC by using its user interface, e.g. a USB-connection or a wireless node, to transfer the configuration data of the old tablet-PC to its personal computer 20 in the same manner as described above. Advantageously, the end-user stores also all the applications, private data and audio/video files of the old tablet-PC on its personal computer 20. In a further step, the end-user then transfers first the configuration data as stored on its personal computer 20 to the new tablet-PC. The new tablet-PC accepts the configuration data only, when the signature of the configuration data matches its device public key, to have the guarantee that the configuration data as stored on the personal computer 20 will work on the new tablet-PC. Then, when the configuration data of the old tablet-PC are stored and installed on the new tablet-PC, the end-user can restore all the applications and other data from the personal computer to the new tablet-PC, so that the end-user can use the new tablet-PC as before with the old tablet-PC. An end-user replaces his smartphone or tablet-PC often by a new one of the same company. In such a case it is advantageous to transfer the configuration data and the applications of the old smartphone to the new smartphone, respectively tablet-PC.

Also other embodiments of the invention may be utilized by one skilled in the art without departing from the scope of the present invention. The service provider network is not necessarily the network service provider network, but can be also any Internet service provider network or the manufacturer of the end-user device. The invention is also in particular not limited to CPE devices, but can be applied also for other end-user devices like smartphones, tablet PCs, etc being connectable via a broadband connection, e.g. an xDSL connection or within a mobile cellular network, to an NSP network. The invention resides therefore in the claims herein after appended.

1. Method for a backup and restore of configuration data of an end-user device, comprising the steps of
encrypting the configuration data by using symmetric-key encryption with a symmetrical key,
signing the encrypted configuration data with a device private key of an asymmetric key encryption system,
sending the encrypted and signed configuration data to a personal computer of a user of the end-user device and/or to a storage location of a service provider network for storage, and
restoring of configuration data of the end-user device by using a first or a second public key for validating signed configuration data provided by the service provider network or for validating signed configuration data stored on the personal computer.

2. Method according to claim 1, comprising the steps of using an administration public key as the second public key for validating the signed configuration data as provided by the service provider network, and
using a device public key as the first public key for validating the signed configuration data stored on the personal computer.

3. Method according to claim 2, wherein the device private key is a device-specific private key, and the device-specific private key, the device public key and the administration public key of the asymmetric key encryption system are keys of an RSA public key algorithm.

4. Method according to claim 1, wherein the symmetrical key is common to a specific model of end-user devices of a service provider network, or is common to all of the end-user devices of the service provider network.

5. Method according to claim 4, wherein the symmetrical key is a shared secret key, for example a key in accordance with the Advanced Encryption Standard.

6. Method according to claim 2, comprising the step of using the restored configuration data for replacing the current configuration data of the end-user device.

7. The method according to claim 2, wherein the device-specific private key and the device public key constitute a first pair of an asymmetric key cryptographic system, and wherein the service provider network adds an administration private key to encrypted configuration data intended for restoring of the configuration data of the end-user device, the administration private key and the administration public key constituting a second pair of an asymmetric key cryptographic system.

8. The method of claim 7, wherein the end-user device uses the administration public key for validating the administration private key in case of restoring of configuration data provided by the service provider network.

9. Method according to claim 9, wherein the end-user device is a customer-premises equipment device and the service provider network is a network service provider network.

10. Method according to claim 9, wherein the customer-premises equipment device is coupled via a broadband connection to an auto configuration server of the network service provider network, and the backup is requested by the network service provider network via the auto configuration server.

11. End-user device, utilizing a method according claim 1.

12. End-user device, comprising
a memory including configuration data, a symmetric key for encrypting the configuration data,
a private key of an asymmetric key encryption system for signing the encrypted configuration data, and
at least a first public key of the asymmetric key encryption system for validating signed configuration data for restoring of the configuration data.

13. The end-user device of claim 12, comprising a first public key of the asymmetric key encryption system for validating signed configuration data provided by a service provider network and a second public key of the asymmetric key encryption system for validating signed configuration data stored by a user of the end-user device on a personal computer of the user.

14. The end-user device of claim 13, comprising a user interface allowing a user of the end-user device to perform backup and restore operations of the configuration data, and a CWMP Client including a TR-069 standard compliant software component to enable the service provider network to perform backup and restore operations of the configuration data, by using a remote location of the service provider network for storage.

15. The end-user device of claim 13, wherein the end-user device is a customer-premises equipment device, a tablet PC or a smartphone.

16. The end-user device of claim 13, the symmetrical key is a shared secret key, for example a key in accordance with the Advanced Encryption Standard, and wherein the symmetrical key is common to a specific model of end-user devices of a service provider network, or is common to all of the end-user devices of the service provider network.
